(19) United States
(12) Patent Application Publication
(10) Pub. No.: US 2025/0222829 A1
(43) Pub. Date: Jul. 10, 2025

(54) METHOD FOR CONTROLLING THE CONFIGURATION FOR A VEHICLE SEAT

(71) Applicant: FAURECIA Sièges d'Automobile, NANTERRE (FR)

(72) Inventors: Samuel BAUDU, BOULOGNE (FR); Nour BESBES, MONTROUGE (FR)

(21) Appl. No.: 19/009,384

(22) Filed: Jan. 3, 2025

(30) Foreign Application Priority Data
Jan. 5, 2024 (FR) 2400107
Mar. 19, 2024 (FR) 2402714

(51) Int. Cl. B60N 2/00; B60N 2/50

(52) U.S. Cl. CPC B60N 2/0033; B60N 2/0025; B60N 2/501

(57) ABSTRACT

A method for controlling the configuration of a vehicle seat, the method comprising:
a) acquiring, at a defined frequency, three pressure values by three sensors arranged on three defined zones of the squab;
b) calculating attributes from the acquired pressure values, the attributes being selected from a standard deviation, a sum, and a first ratio;
c) determining a seat destination configuration from the calculated attributes, by applying a trained classification model,
d) transmitting a motion command signal to mobile motorized mechanisms, the motion command signal being suitable for causing the seat to move towards the determined destination configuration.

### PRIORITY CLAIM

This application claims priority French Patent Application No. FR2400107, filed Jan. 5, 2024, and French Patent Application No. FR2402714, filed Mar. 19, 2024, each of which is expressly incorporated by reference herein.

### BACKGROUND

The present disclosure relates to the field of embedded vehicle systems.

### SUMMARY

According to the present disclosure, a system and a method are proposed for automatically proposing a seat configuration to an occupant that is both conducive to correct posture and adapted to each occupant (particularly their body shape). In addition, the solutions proposed here make it possible to limit the number and duration of actions and reference positions imposed on the seat occupant, so the system can operate as it should. In other words, the aim here is to increase the degree of automation of the initial settings of a seat configuration so that this adjustment phase is natural and virtually unfelt by the seat occupant. A seat equipped with such a system and receiving an occupant for the first time will automatically modify its configuration until it detects a compliant posture from the seat's occupant, without the occupant even needing to control, or even voluntarily trigger, such an adaptation.

The seat configuration can be adjusted in a plurality of steps. Nevertheless, these successive steps can be sequenced automatically without waiting for any voluntary or even conscious action on the part of the seat occupant to move from one step to the next. From the occupant's point of view, the adjustment therefore seems to be continuous, rapid, and a one-step process.

In particular, the present disclosure relates to a method for controlling the configuration of a vehicle seat, the seat having a squab and a backrest, the method being implemented by a controller, the method comprising:
a) acquiring, at a defined frequency, at least three pressure values by at least three sensors arranged on at least three defined zones of the squab;
b) calculating at least two attributes from at least two of the three acquired pressure values, the calculated attributes being selected from a standard deviation, a sum, and a first ratio;
c) determining a seat destination configuration from the calculated attributes, by applying a trained classification model,
d) transmitting at least one motion command signal to mobile and motorized mechanisms, the at least one motion command signal being suitable for driving at least one movement of the seat towards the determined destination configuration.

According to one particular embodiment, the calculation step comprises calculating three attributes and determining a seat destination configuration from the three calculated attributes, by applying the trained classification model.

According to one particular embodiment, the squab comprises at least one first sensor arranged on a right rear zone, at least one second sensor arranged on a left rear zone, and at least one third sensor arranged on a right front zone and wherein the standard deviation is calculated from at least one pressure value acquired by the first sensor, at least one pressure value acquired by the second sensor, and at least one pressure value acquired by the third sensor.

According to one particular embodiment, after the at least one motion command signal has been transmitted, the method comprises:
e) calculating a ratio between the pressure value acquired by the third sensor and the pressure value acquired by the first sensor, and
f) comparing the ratio with a first threshold,
g) when the ratio is greater than the first threshold, at least one stop command signal is emitted to the mobile motorized mechanisms, the at least one stop command signal is suitable for stopping the at least one movement of the seat, and when the ratio is less than the first threshold, steps d) and e) are iterated with the next pressure value acquired by the third sensor and the next pressure value acquired by the first sensor.

In a particular embodiment, when the ratio remains below the first threshold, the seat movement is stopped when the seat reaches the destination configuration.

According to one particular embodiment, the method comprises placing the seat in a reference position in which a front edge of the squab is placed at a distance from a vehicle pedal, preferably an accelerator pedal; the distance being between 450 millimeters and 520 millimeters in a longitudinal direction.

According to one particular embodiment, the method further comprises the detection of at least one start of pedal depression, preferably of an accelerator pedal; and wherein the at least two attributes entered in the trained classification model are acquired within the second preceding the detection.

In a particular embodiment, the method comprises detecting a degree of pedal depression of at least 50% of the stroke of the pedal, the detection triggering the determination of a seat destination configuration.

In a particular embodiment, the sum is calculated from at least one pressure value acquired by the first sensor and at least one pressure value acquired by the second sensor.

In a particular embodiment, the first ratio is calculated from at least one pressure value acquired by the third sensor and at least one pressure value acquired by the first sensor.

According to one particular embodiment, the squab comprises at least one fourth sensor located on a front-left zone, and wherein the standard deviation is calculated from at least one pressure value acquired by the first sensor, at least one pressure value acquired by the second sensor, at least one pressure value acquired by the third sensor and at least one pressure value acquired by the fourth sensor.

According to one particular embodiment, the backrest comprises at least one fifth sensor located in an upper-right zone and/or at least one sixth sensor located in an upper-left zone, and which comprises the calculation of an additional attribute, the additional attribute comprising a second ratio between, on the one hand, at least one pressure value acquired by at least one of the fifth sensor and the sixth sensor and, on the other hand, at least one pressure value acquired by at least one of the third sensor and the fourth sensor.

According to one particular embodiment, the backrest comprises at least one fifth sensor located in an upper-right zone and at least one sixth sensor located in an upper-left zone, the calculation of an additional attribute, the additional attribute comprising a second ratio between, on the one hand, the sum of at least one pressure value acquired by the fifth sensor and at least one pressure value acquired by the sixth sensor and, on the other hand, the sum of at least one pressure value acquired by the third sensor and at least one pressure value acquired by the fourth sensor.

In a particular embodiment, the trained classification model is a decision tree.

According to one particular embodiment, the motion command signal emitted is configured to cause at least one movement from among:
moving the squab backwards or forwards relative to the reference position in the longitudinal direction of the vehicle;
lowering or raising the squab relative to the reference position in a vertical direction;
tilting the squab relative to the reference position at and along a transverse axis,
raising or lowering the headrest relative to the reference position.

The present disclosure also relates to a computer program comprising instructions for implementing the above-described method, when this program is executed by a processor.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a system.

FIG. 2 shows a seat equipped with sensors used in the control method according to the present disclosure.

FIG. 3 shows a control method according to a first embodiment.

FIG. 4 shows a method according to second first embodiment.

### DETAILED DESCRIPTION

In the following description, the spatial positioning indications such as top, bottom, upper, lower, horizontal, vertical, etc. are given for the clarity of the description, as a function of the usual use position of the seat, but are not limiting. More particularly, the orientations relative to the front and the rear of the seat relate to the usual use position of the seat. In the longitudinal direction X, a horizontal direction is understood to extend between the front and the rear of the vehicle seat. The transverse direction Y refers to a horizontal direction, extending from one side of the vehicle seat to the other side of the vehicle seat. The vertical direction Z means the direction perpendicular to the longitudinal X and transverse Y directions.

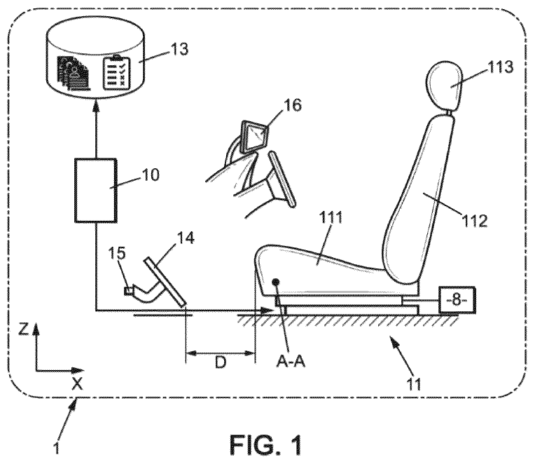

Reference is now made to FIG. 1. The on-board vehicle system 1 comprises at least:
a seat 11 suitable for receiving a vehicle occupant and equipped with mobile, motorized mechanisms 8 suitable for modifying the configuration of the seat 11;
a set of sensors 12 jointly arranged to detect the posture of the occupant of the seat 11, at least some of which are integrated into the seat 11; and
a controller 10 able to receive signals as input from the set of sensors, and to generate command signals as output for the mechanisms. The controller is further configured to implement a seat configuration method.

The seat 11 comprises a squab 111 and a backrest 112 articulated on the squab, and a headrest 113.

For the purposes of this description, a vertical transverse plane (Y, Z) and a vertical longitudinal plane (X, Z) are defined. The vertical transverse plane (Y,Z) lies midway between a front edge 114 of the squab and a rear edge 115 of the squab. The vertical longitudinal plane (X, Z) lies midway between the two side edges 116, 117 of the squab. These plans define four zones on the squab.

The squab 111 comprises a front zone located in front of the vertical transverse plane (Y,Z), and a rear zone located behind the vertical transverse plane (Y,Z). The rear zone comprises a right rear zone ZRD arranged on one side of the vertical longitudinal plane (Y,Z), and a left rear zone ZRG arranged on the other side of the vertical longitudinal plane (Y,Z). Likewise, the front zone comprises a right front zone ZAD arranged on one side of the vertical longitudinal plane (Y,Z), and a left front zone ZAG arranged on the other side of the vertical longitudinal plane (Y,Z).

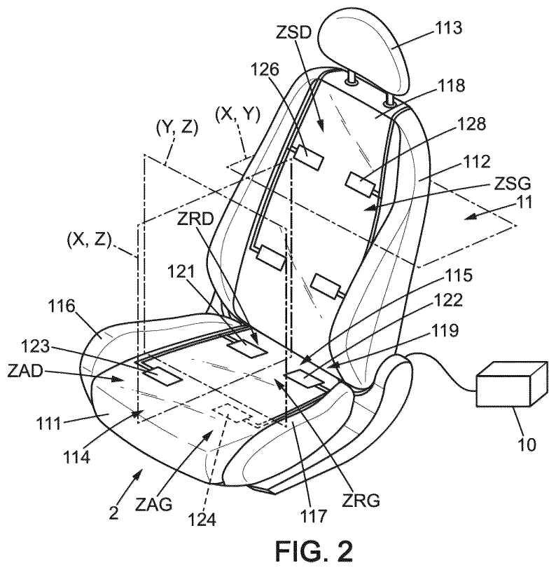

In the example shown in FIG. 2, the set of sensors 12 comprises three sensors arranged on the squab. A first sensor 121 is located on the right rear zone ZRD of the squab. A second sensor 122 is located on the left rear zone ZRG. A third sensor 123 is located on the right front zone ZAD of the seat.

In one variant, the set of sensors 12 comprises four sensors arranged on the squab. In this case, a fourth sensor 124, shown in dotted lines, is located in the front left zone ZAG of the seat. The use of four sensors improves measurement accuracy.

The set of sensors comprises pressure sensors configured to measure pressure values exerted on the squab. Advantageously, the pressure sensors are capacitive sensors with coplanar interdigitated electrodes. An example of such a sensor is disclosed in patent application FR 3126776 in the name of the applicant. Such a sensor comprises an electrode connected to a voltage source of around 5 Volts and a grounded electrode. A capacitance value representative of a pressure value is measured across these electrodes.

Preferably, the backrest 112 further comprises at least a fifth sensor 126. To define the position of this sensor in the present patent application, a horizontal transverse plane (X, Y) is defined. The horizontal transverse plane (X, Y) extends between an upper edge 118 and a lower edge 119 of the backrest, at the midway point. This plan defines two zones on the backrest. An upper right zone ZSD is located on one side of the vertical longitudinal plane (X, Z) and above the horizontal transverse plane (X, Y). An upper left zone ZSG is located on the other side of the vertical longitudinal plane (X, Z) and above the horizontal transverse plane (X, Y). The fifth sensor 126 can be arranged above the horizontal transverse plane (X, Y). Preferably, the fifth sensor 126 is located on the upper right zone ZSD of the backrest. To simplify the figure, the vertical longitudinal plane defined for the squab is used to define the backrest zones.

Preferably, the backrest 112 further comprises at least a sixth sensor 128. The sixth sensor is located in the upper left zone ZSG of the backrest.

The mobile, motorized mechanisms 8 comprise a first system for moving the squab relative to the floor of the passenger compartment of a motor vehicle. This first system comprises, for example, two slideways and two moving elements that can be moved along the slideways. The squab 111 is carried by the moving elements. The slideways are intended to be attached to the floor of the passenger compartment. The squab 111 is able to move in the longitudinal direction X during the movement of the two moving elements along the slideways. The mobile motorized mechanisms further comprise a first actuator configured to operate this first motion system and to cause a transmission mechanism to move the moving elements on the slideways and move the seat in the longitudinal direction X.

By convention, in the present patent application, the front part of the slideways is considered to be the part closest to the pedal(s), and the seat is at the start of its stroke when the seat is located closest to the front part of the slideways. It is considered that between 1% and 49% of the stroke of the moving elements on the slideways, the seat is closer to the front part of the slideways than to the rear part of the slideways.

Preferably, the squab 111 can be lowered or raised. To this end, the mobile motorized mechanisms 8 comprise a second motion system for movement along the vertical axis Z, enabling the squab to be raised and lowered relative to the slideways and the vehicle floor, and a second actuator for driving this second motion system.

Preferably, the squab 111 is pivotably mounted with respect to the moving elements. In such a case, the squab is articulated to the moving elements about a pivot axis A-A directed in the transverse direction Y. In this case, the mobile motorized mechanisms 8 comprise a third motion system for pivoting the squab about the pivot axis A-A and a third actuator for driving this third motion system.

Preferably, the headrest 113 is slidably mounted relative to the backrest in the vertical direction Z. In this case, the mobile motorized mechanisms 8 further comprise a fourth motion system for sliding the headrest relative to the backrest and a fourth actuator for driving this fourth motion system.

The on-board system 1 can be supplemented by a database 13 stored on a suitable memory to which the controller 1 and/or a human-machine interface 16 has access.

The on-board system 1 may comprise a unit 15 for receiving or generating information relating to accelerator pedal depression, such as an accelerator pedal sensor, or a unit for retrieving this information from the engine control unit (ECU).

The term “seat configuration” is used here in its broadest sense. This covers, for example, the relative positions and orientations of the various components of the seat in relation to each other (for example, but not limited to, the tilt of the backrest 112 in relation to the squab 111 and/or the position of the headrest 113 in relation to the backrest), and also the positions and orientations of the various components 111, 112, 113 of the seat 11 in relation to the rest of the vehicle such as the passenger compartment (for example, but not limited to, the advancement and height of the squab 111).

For ease of understanding, the following examples refer to the driving position of a “personal” car, a situation common to many readers. Other reference positions can be provided. For example, resting positions can be configured to facilitate resting between two driving sessions, rather than while driving (with the vehicle stationary). Other driving/piloting or resting positions can be provided in other contexts and other vehicles, such as aircraft, trains, passenger and/or freight vehicles, etc.

Advantageously, the method of controlling the configuration of a seat can be combined with a function of returning to an accommodating position in the absence of an occupant: when the controller 10 receives one or more dedicated command signals from the sensors 12 indicating the absence of an occupant, the controller 10 transmits command signals so that the seat mechanisms operate to cause the seat to adopt the accommodating position, facilitating the seating of an occupant in the seat and in the vehicle, or their unseating. The accommodating position corresponds, for example, to a position of the squab 111 that is set back as far as possible, so that even taller people can settle in easily. The accommodating position can be independent of the occupants.

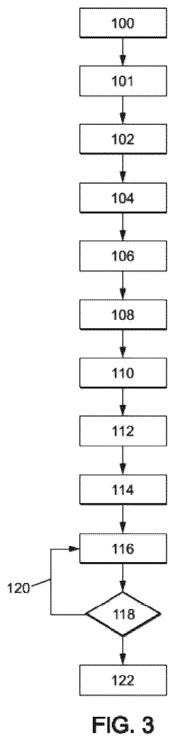

Reference is now made to [FIG. 3]. The control method begins with a training phase 100 of a classification model trained from pressure values collected on a seat 11. For each type of seat, a new classification model will have to be trained.

When an occupant sits on the seat 11, the configuration control method comprise a step 101 for placing the seat in a reference position. For this purpose, the seat 11 is moved forward in the direction of the vehicle's pedal(s). The pedal can be an accelerator pedal, a brake pedal, or a clutch pedal. The reference position allows anyone, regardless of height or build, to place their foot on a pedal, especially the accelerator pedal. Preferably, when the seat is in the reference position, the front edge 114 of the squab is positioned at a distance of between 450 millimeters and 520 millimeters from a pedal, for example the accelerator pedal. The distance D is measured from the edge of the pedal closest to the seat. This distance is measured in the longitudinal direction X only. In the reference position, the seat can also be positioned at a defined height in the direction Z. The seat can be tilted to a defined angle. The headrest can be positioned at a defined height.

The method then comprises a step 102 for acquiring pressure values generated by the first sensor, the second sensor and the third sensor. This acquisition is for example carried out by a capacitance meter. A clock can be set. The pressure values are, for example, capacitance values measured between the electrodes of each capacitive sensor. The pressure values measured by each sensor are stored and can be associated with time information generated by the clock. Pressure values are acquired, for example, at a frequency of 100 milliseconds. Here, pressure values are acquired during the entire control method.

The occupant seated on the seat places their foot on a pedal and in a step 104, the start of a pedal depression is detected by the unit 15.

The pedal can be the accelerator pedal, the brake pedal, or the clutch pedal. Preferably, the pedal is the accelerator pedal. In the following description, the accelerator pedal is described by way of example.

Then, in a step 106, the seat occupant issues a request to control the seat configuration. In other words, the occupant asks for the position and seat to be adjusted automatically. This request can, for example, be implemented by pressing hard on the accelerator pedal. This hard press is detected by the unit 15. For example, the detection of a degree of depression of at least 50% of the stroke of the accelerator pedal can be considered as a request to control the seat configuration. Preferably, the detection of a degree of depression of 70% of the stroke of the accelerator pedal can be considered as a request to control the seat configuration. Alternatively, information on the degree of accelerator pedal depression can be transmitted by the engine control unit (ECU).

In step 108, a pressure value acquired by each sensor just before the start of pedal depression is selected. The number of pressure values selected here is equal to the number of sensors arranged on the seat.

Alternatively, a plurality of pressure values can be selected for each sensor. In this case, an average value is calculated from these selected pressure values.

In step 110, at least two attributes are calculated from the pressure values selected in step 108. The attributes are also referred to as discriminating factors. The calculated attributes are then entered into the trained classification model. A decision tree can be used as a trained classification model. In this decision tree, a condition is checked at each internal node. The conditions are based on attributes.

When the seat 11 comprises the first sensor 121, the second sensor 122 and the third sensor 123, the calculated attributes are selected from a standard deviation σ, a sum So, and a first ratio R1.

Preferably, the attributes calculated in step 110 comprise a standard deviation σ and a sum So.

The standard deviation σ is calculated using the formula below:

$$\sqrt{\frac{1}{n} {\sum }_{i = 1}^{n} {( {x}_{i} - \overline{x} )}^{2}}$$

where n is the number of pressure sensors arranged on the squab; xi are the pressure values acquired by each sensor and x̅ is the average of the acquired pressure values.

The standard deviation σ is calculated from at least three pressure values. Preferably, the standard deviation σ is calculated from the pressure value acquired by the first sensor 121, the pressure value acquired by the second sensor 122, and the pressure value acquired by the third sensor 123.

The sum So is the sum of two pressure values. Preferably, the sum So is the sum of the pressure value acquired by the first sensor 121 and the pressure value acquired by the second sensor 122.

Alternatively, the attributes calculated in step 110 comprise a standard deviation σ and a sum So and the first ratio R1.

The first ratio R1 is the ratio between two pressure values. Preferably, the first ratio R1 is the ratio between a pressure value acquired by the third sensor 123, and a pressure value acquired by the first sensor 121.

When the squab further comprises a fourth sensor 124, the standard deviation σ is calculated from the pressure values acquired by the first sensor 121, the second sensor 122, the third sensor 123 and the fourth sensor 122. Preferably, these pressure values are the pressure values selected in step 108.

When the backrest further comprises a fifth sensor 126 and a sixth sensor 128, the method involves calculating 111 an additional attribute. This additional attribute includes a second ratio R2. In this embodiment, the second ratio is the ratio between, on the one hand, the sum of a pressure value acquired by the fifth sensor 126 and a pressure value acquired by the sixth sensor 128 and, on the other hand, the sum of a pressure value acquired by the third sensor 123 and a pressure value acquired by the fourth sensor 124. Preferably, these pressure values are the pressure values selected in step 108.

When the backrest only comprises the fifth sensor 126, the second ratio R2 is the ratio between, on the one hand, at least one pressure value acquired by the fifth sensor 126 and, on the other hand, at least one pressure value acquired by the third sensor 123. When the backrest only comprises the sixth sensor 128, the second ratio R2 is the ratio between, on the one hand, at least one pressure value acquired by the sixth sensor and, on the other hand, at least one pressure value acquired by the fourth sensor 124.

In a step 112, the trained classification model, and in particular the decision tree, determines a seat destination configuration. Here, each destination configuration corresponds to a leaf node or terminal node of the decision tree. One or more motion commands are sent to one or more motion systems to move the seat to this destination configuration. However, the destination configuration is a possible but not certain final configuration. The seat can stop before reaching the determined destination configuration, when a condition is met, as explained below.

Destination configurations are selected or determined from the following destination configurations:
a first configuration S wherein the seat is advanced towards the pedal(s), for example to the beginning of its stroke. The squab can be raised to the end of its stroke. The squab can be tilted counter-clockwise around the pivot axis A-A to lower the nose of the squab. The headrest can be lowered. This first configuration is potentially intended for an occupant with a height of between 155 centimeters and 164 centimeters.
a second configuration M wherein the seat is moved back from the reference position to a position between 60% and 70% of the total stroke of the slideways. The squab, for example, is raised. For example, the squab is tilted counter-clockwise around the pivot axis A-A to lower the nose of the squab from its reference position. The headrest, for example, is raised from its reference position. The second configuration M is intended for an occupant with a height of between 165 centimeters and 174 centimeters.
a third configuration L wherein the seat is moved back from the reference position to a position between 70% and 85% of the total stroke of the slideways. The squab can be moved in the direction Z relative to its reference position. The squab can be tilted from its reference position. The headrest can be moved from its reference position. The third configuration L is intended for an occupant with a height of between 175 centimeters and 184 centimeters;
a fourth configuration XL wherein the seat is moved back from the reference position to a position approximately 95% of the total stroke of the slideways. The squab can be lowered to the bottom of its stroke. The squab can be tilted clockwise around the pivot axis A-A to raise the nose of the squab. The headrest can be raised from its reference position. The fourth configuration XL is configured for an occupant with a height of over 185 centimeters.

In a step 114, at least one motion command signal is sent to the mobile motorized mechanisms 8. This motion command signal is able to cause at least one movement of the seat towards the specified destination configuration.

The motion command signal emitted is configured to cause at least one movement from among:
moving the squab backwards or forwards relative to the reference position in the longitudinal direction (X) of the vehicle;
lowering or raising the squab relative to the reference position in a vertical direction (Z);
tilting the squab relative to the reference position at and along a transverse axis (Y),
raising or lowering the headrest relative to the reference position.

For example, the first internal node checks whether the standard deviation calculated from the three pressure values is below a threshold level N1 calculated by the trained classification model. If this is the case, the trained classification model determines that the destination configuration is the first configuration. A motion command signal is sent to the mobile motorized mechanisms 8 so that the squab moves in a longitudinal direction X towards the pedal. A motion command signal can also be emitted to raise the squab, to tilt the squab and/or to raise the headrest.

Then, in a step 116, the controller 10 calculates a ratio Rt between a pressure value acquired by the third sensor 123 after the motion command signal is transmitted and a pressure value acquired by the first sensor 121 after the motion command signal is transmitted.

Alternatively, an average value obtained from a plurality of pressure values can be used to calculate this ratio Rt.

In a step 118, the ratio Rt is compared with a first threshold S1.

If the ratio is greater than threshold S1, at least one stop command signal is sent in a step 120. The stop command signal is used to stop seat movement(s).

If the ratio is below the threshold S1, the steps 116 and 118 are repeated in a step 122 for each new pressure value acquired by the third sensor 123 and the first sensor 121. If the ratio Rt remains below the first threshold S1, the seat movement is stopped when the seat reaches the destination configuration.

According to a less advantageous variant, if the accelerator pedal control is implemented by a manual control, the triggering step 104 can be implemented by the seat occupant placing his their foot on a support located in the usual place of the accelerator pedal. In this case, the on-board system 1 may comprise a support and a trigger element such as a foot presence sensor or a trigger button. In this case, the seat reference position is defined by the distance between the edge of the shelf facing the seat and the front edge of the seat.

Alternatively, the pressure values selected in step 108 are pressure values acquired after the detection of a start 104 of pedal depression or even after the detection 106 of a determination request, for example by detecting a defined degree of accelerator pedal depression.

Alternatively, the request for automatic seat adjustment is made by voice command or by pressing a button during the step 106.

Alternatively, a model other than the decision tree can be used as a trained classification model, e.g. Random Forests, Support Vector Machines (SVM).

The present disclosure further relates to a method for automatically adjusting the configuration of a seat. This method comprises the steps described below.

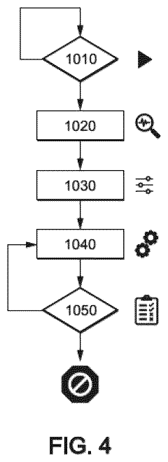

Reference is now made to [FIG. 4]. Firstly, the configuration adjustment process comprises a first step 1010 of triggering. The first step 1010 can be triggered by a dedicated command such as a physical or virtual button, or a command to unlock the vehicle or open the driver's door, or a voice command for example. Then, the system can send a signal to the occupant, via the human-machine interface 16, for example in the form of a written or voice message, inviting that person to adopt a reference posture.

For greater efficiency, the method can be triggered by the detection of a reference posture of the seat occupant, in particular a posture that is conducive to the measurement of parameters used to determine a seat configuration.

In the example of a car driver's seat, the method can be triggered by detecting the position of the accelerator pedal 14, for example when fully depressed. The trigger can also be a combination of conditions. If, for example, one wishes to prevent triggering while the vehicle is being driven, an additional condition can be set: The vehicle is stationary or at reduced speed. For example, the trigger is a combination of a fully depressed position of the accelerator pedal 14 and a stopped engine.

The condition or combination of conditions acting as a trigger can also be made necessary for the continuation of the method. In this case, exiting the trigger conditions acts as a command to stop the method. For example, the controller 10 can be configured to interrupt the process when it is detected that the accelerator pedal 14 has exited its fully depressed position and/or the pedal is no longer depressed and/or the engine has turned on.

Alternatively, the measured data can be filtered. In particular, for the determination of the first set of indicators described below, only some of the measured data may be retained. For example, only data measured before the trigger itself can be retained. This type of filtering reduces the risk of the measurements being interfered with by a one-off effort on the part of the occupant linked to the trigger action, i.e. the depression of the accelerator pedal in the above example. In other words, since the measurements are intended to be representative of the occupant's natural, comfortable posture, it may be preferable to ignore those which correspond to a particular situation, such as the triggering of the method. Using measured data from the occupant's posture in the second or few seconds before the pedal is partially or fully depressed can therefore be advantageous. It should also be noted that the more the effort needed for triggering varies from one individual to another, the more advantageous it is to eliminate such a measurement bias through such filtering. Thus, a variant with such filtering is more relevant when the trigger corresponds to the pressing of a pedal than when the trigger corresponds to the pressing of a button. In fact, the effort needed to depress a pedal depends on the occupant's body shape/build, which is not the case for pressing a button.

In a second step 1020, a first set of indicators can be determined. One of the first indicators may relate to a physical characteristic of the occupant, such as their height. In the above example of the accelerator pedal depressed all the way, combined with the presence of a sensor 12 capable of measuring the degree of advancement of the seat squab and at least one sensor 12 capable of determining the position of the occupant's buttocks on the squab, the controller 10 can then deduce a distance separating the occupant's right heel from their buttocks, and thus indirectly extrapolate their height. The range of values for the first indicator can be substantially infinite (e.g. a height in centimeters) or predetermined (e.g. “small”/“S” for 155 to 164 cm, “medium”/“M” for 165 to 174 cm, “large”/“L” for 175 to 184 cm or “very large”/“XL” for more than 184 cm). The first set of indicators may comprise a single indicator or several.

The first set of indicators can, for example, be obtained by implementing an algorithm by the controller 10, based on signals from the sensors 12. The algorithm includes calculations combining values derived from the measurement signals from the sensors, for example averages or standard deviations of the pressures applied by the occupant's body to various portions of the seat.

In a third step 1030, the controller can determine a first set of target values based on the first set of indicators. As explained in more detail below, at least some of the target values can also be considered as stop conditions (for seat configuration modification). Following the previous example, the first set of target values may comprise a position of the squab 111 of the seat 11 relative to the rest of the vehicle. The match between the first set of indicators and the first set of target values is pre-established, by means of matching tables and/or calculation algorithms implemented by the controller 10. In the previous example, the taller the occupant is determined to be, the further back (away from the pedal 14) the target position of squab 111 will be, and vice versa. Each target value can be a single value or a range of values. A second example of target values is a pressure measured by a pressure sensor 12 located in the squab 111 and/or backrest 112 of the seat 11.

Of course, the example of the link between the occupant's height and the position of the squab 111 for the second and third steps 1020, 1030 above can be transposed to other examples of measurements and can replace or combine with each other.

In a fourth step 1040, the controller 10 transmits command signals so that the seat mechanisms are actuated to bring the measured values closer to the target values thus determined. For example, if the seat's initial configuration is the accommodating configuration described above, then the squab 111 starts from a position as far back as possible and moves forward (towards the pedals).

A feedback loop is implemented. In a fifth step 1050, the controller 10 checks, on the basis of the signals received, whether one of the stop conditions has been reached, and if so, interrupts the method. The fifth step 1050 can be concomitant with the fourth step 1040; it can be implemented continuously or periodically (in a loop), for example every 100 milliseconds.

There may be multiple stop conditions, for example:
a command signal from a human-machine interface 16 (the occupant can stop the method manually, for example by means of a physical or virtual button);
the measurement signals received indicate that at least some of the (customized) target values determined in step 1030 have been reached;
the measurement signals received indicate the attainment of preset (non-customized) limit values, or end-of-stroke stop signals.

When a plurality of seat 11 configuration parameters are provided (for example, the horizontal position of the squab 111 and the tilt of the backrest 112 relative to the squab 111), the fifth step 1050 can be:
combined; meeting a single stop condition results in complete interruption of the method;
broken up; meeting a single stop condition results in only partial interruption of the method; for example, the horizontal position of the squab 111 reaches its target value and the movement of the squab 111 stops, while the tilt of the backrest 112 has not yet reached its target value and the backrest 112 therefore continues to tilt;
hybrid; certain stop conditions (e.g. receiving a command signal from the human-machine interface) cause the method to be completely interrupted, while other stop conditions are broken up from one another.

Optionally, some of the target values determined in the third step 103′ do not constitute stop conditions in the fifth step 1050. For example, if the target values for the horizontal position of the squab 111 are defined by a range of values whose bounds are Xₘᵢₙ and Xₘₐₓ, the controller can be configured to assume that:
reaching a value X out of the range [Xₘᵢₙ; Xₘₐₓ] towards the inside of the range is not a stop condition;
subsequently reaching one of the bounds while the X value was within the target range may or may not be a stop condition.

In such a case, it becomes possible (but optional) during the fourth and fifth steps 1040, 1050 to determine a second set of target values, generally more complete and precise than the first. For example, if it is detected by the controller 10 that one of the target values, such as a pressure measured in the squab 111 and/or back 112, is reached when the horizontal position of the squab 111 reaches a value X₁, then the second set of target values determined may include the value X₁. This value X₁ may lie within the range [Xₘᵢₙ; Xₘₐₓ] initially determined (X₁ is therefore a “refined” target value) or not (X₁ is therefore a “corrected” target value). In such embodiments, the second set of target values can, for example, be stored and associated with an occupant identifier (referred to as a “profile”). The second set of target values can subsequently be implemented if and when the same occupant settles back into the seat 11 to more quickly bring the seat 11 into a configuration that matches the occupant. The second set of target values can also be used more generally to supply the matching tables of system 1, or even to replace the “factory” values of the matching tables. In the latter case, the system 1 is evolutionary and “learns” through use.

Among the target values that can be determined in the third step 1030 and that act as a stop condition in the fifth step 1050, the applicant has identified some particularly effective embodiments. In particular, some of the target values may be combinations of values obtained from a plurality of sensors. For example, when the system 1 comprises at least a first pressure sensor 12 located in the front part of the squab 111 of the seat 11 and a second pressure sensor 12 located in the rear part of the squab 111 of the seat 11, a target value can take the form of a pressure ratio of one over the other. In particular, the applicant has found that this enabled a suitable seat configuration to be detected quickly and reliably, especially with regard to the distance between the squab 111 and the accelerator pedal 14. Indeed, by using a pressure ratio rather than absolute pressure values, it becomes possible to better qualify a position of the occupant's thigh and leg, independently of their weight for example. Such a solution can be transposed to the backrest 112 of the seat 12, for example, to provide that the occupant's back is supported substantially evenly and to avoid extreme and harmful postures, such as leaning too far forward or slouching too far back. The same applies to pairs of side sensors 12 to detect presumed harmful asymmetries (such as the rotation of the occupant's trunk). Alternatively, a plurality of values can be combined using calculations other than “ratios” (division of one by the other). For example, standard deviations or averages can be calculated from values obtained indirectly from sensors.

In the above examples, at least some of the input data for the controller 10 comes from measurement signals from sensors 12. The set of sensors 12 may include, for example, pressure or interdigitated sensors integrated into the seat 11, position sensors for the various parts of the seat 11 or other vehicle components such as the position of the accelerator pedal 14. The controller can be connected directly to dedicated sensors of the system. Alternatively, the input signals can come indirectly from sensors not specific to the system. For example, the position of the accelerator pedal 14 may be available for functions other than those described here. It can be obtained via a vehicle on-board computer, for example by connecting the controller 10 to a vehicle data bus. Similarly, the controller 10 can be a dedicated unit for implementing the method described here, or it can be integrated into other vehicle systems and implement other functions not described here. For example, the system described here can be fitted to an existing vehicle or integrated into the vehicle from its design stage.

This disclosure is not limited to the examples of systems and method which are described above, solely by way of example, but it encompasses all the variants that the person skilled in the art may consider in the context of the protection sought. This includes computer programs containing instructions for implementing all or part of a method as defined herein, where the program is executed by a processor, or non-transitory computer-readable recording media on which such a program is recorded.

The present disclosure also relates to a A) A method for automatically adjusting the configuration of a vehicle seat implemented by a controller (10) and comprising:
a. determining (1020) a first set of seat occupant-specific indicators as a function of signals from a set of sensors, at least some of the sensors being integrated in the seat;
b. determining (1030) a first set of target values as a function of the first set of indicators;
c. transmitting (1040) command signals to mobile mechanisms of the seat so that the mechanisms are actuated and values measured via the sensors approach the determined target values;
d. checking (1050) that preset conditions have been met to interrupt the method and the actuation of the mechanisms, at least some of the preset conditions involving reaching the target values determined by the measured values.
B) The method according to A), wherein the determination (1020) of the first set of indicators is carried out as a function of signals from a set of sensors when the seat is in an initial reference configuration.
C) The method according to A) or B), wherein the triggering of the determination (1020) of the first set of indicators is generated by the detection of a reference posture of the seat occupant.
D) The method according to C), wherein the reference posture includes the depression of a pedal by the seat occupant.
E) The method according to claim D), wherein the determining (1020) of the first set of indicators specific to a seat occupant is carried out as a function of signals from a set of sensors acquired in the second preceding the depression of a pedal by the seat occupant.
F) The method according to A), wherein at least one of the target values is determined by combining two values from at least one pair of sensors.
G) The method according to F), wherein the sensors of a pair are spaced apart and integrated into a one-piece part of the seat.
H) The method according to A), wherein the sensors of a pair are respectively integrated:
   in a front part and a rear part of a squab of the seat; and/or
   in a left and a right part of a squab of the seat; and/or
   in a top part and a bottom part of a backrest of the seat; and/or
   in a left and a right part of a backrest of the seat.
I) The method according to A), wherein the command signals are generated for mobile seat mechanisms capable of modifying at least one of the following parameters:
   the forward position of the squab of the seat in relation to the rest of the vehicle;
   the height of the squab of the seat relative to the rest of the vehicle;
   the tilt of the squab of the seat, or of the front part of the squab of the seat, around a pitch axis;
   the tilt between the squab of the seat and the backrest of the seat.

The present disclosure further relates to a vehicle on-board system (1) comprising:
a seat (11) suitable for receiving a vehicle occupant and equipped with mobile, motorized mechanisms suitable for modifying the configuration of the seat;
a set of sensors (12) jointly arranged to detect the posture of the occupant of the seat, at least some of which are integrated into the seat; and
a controller (10) able to receive signals as input from the set of sensors, and to generate command signals as output for the mechanisms,
the controller (10) being configured to implement a method according to the features mentioned above.

The present disclosure also relates to a computer program comprising instructions for implementing the method according to the features mentioned above, when this program is executed by a processor.

The present disclosure further relates to a non-transitory computer-readable recording medium whereupon a program is recorded for implementing the method according to the features mentioned above, when this program is executed by a processor.

A comparative vehicle seat may store one or more configurations of the vehicle seat and to control various motorized mechanisms as a function of such information to give the seat a previously stored configuration. In this way, a regular occupant of such a seat can quickly find a memorized configuration, particularly when individuals of different body shapes take turns occupying the same seat, and therefore regularly modify the seat configuration to suit themselves. However, this requires each occupant to set each seat configuration parameter once in order to save it. As the configuration parameters can be numerous, these initial settings can be time-consuming.

In addition, the user tends to quickly choose a seat configuration that seems comfortable at a given moment. However, the chosen configuration may be inappropriate in the long term, as it tends to inadvertently encourage poor posture, particularly when driving a vehicle for several hours at a time. This can lead to discomfort, or even pain, which affects driving safety.

There are also comparative systems configured to alert the occupant of a seat if poor posture is detected. To correct posture, the occupant can then modify the comparative seat configuration. It also means that the seat occupant has to spend time trying out different configurations until that person finds a suitable one.

The present disclosure improves the situation.

A system and a method are proposed for automatically proposing a seat configuration to an occupant that is both conducive to correct posture and adapted to each occupant (particularly their body shape). In addition, the solutions proposed here make it possible to limit the number and duration of actions and reference positions imposed on the seat occupant, so the system can operate as it should. In other words, the aim here is to increase the degree of automation of the initial settings of a seat configuration so that this adjustment phase is natural and virtually unfelt by the seat occupant. A seat equipped with such a system and receiving an occupant for the first time will automatically modify its configuration until it detects a compliant posture from the seat's occupant, without the occupant even needing to control, or even voluntarily trigger, such an adaptation.

The seat configuration can be adjusted in a plurality of steps. Nevertheless, these successive steps can be sequenced automatically without waiting for any voluntary or even conscious action on the part of the seat occupant to move from one step to the next. From the occupant's point of view, the adjustment therefore seems to be continuous, rapid, and a one-step process.

In particular, the present disclosure relates to a method for controlling the configuration of a vehicle seat, the seat having a squab and a backrest, the method being implemented by a controller, the method comprising:
a) acquiring, at a defined frequency, at least three pressure values by at least three sensors arranged on at least three defined zones of the squab;
b) calculating at least two attributes from at least two of the three acquired pressure values, the calculated attributes being selected from a standard deviation, a sum, and a first ratio;
c) determining a seat destination configuration from the calculated attributes, by applying a trained classification model,
d) transmitting at least one motion command signal to mobile and motorized mechanisms, the at least one motion command signal being suitable for driving at least one movement of the seat towards the determined destination configuration.

According to one particular embodiment, the calculation step comprises calculating three attributes and determining a seat destination configuration from the three calculated attributes, by applying the trained classification model.

According to one particular embodiment, the squab comprises at least one first sensor arranged on a right rear zone, at least one second sensor arranged on a left rear zone, and at least one third sensor arranged on a right front zone and wherein the standard deviation is calculated from at least one pressure value acquired by the first sensor, at least one pressure value acquired by the second sensor, and at least one pressure value acquired by the third sensor.

According to one particular embodiment, after the at least one motion command signal has been transmitted, the method comprises:
e) calculating a ratio between the pressure value acquired by the third sensor and the pressure value acquired by the first sensor, and
f) comparing the ratio with a first threshold,
g) when the ratio is greater than the first threshold, at least one stop command signal is emitted to the mobile motorized mechanisms, the at least one stop command signal is suitable for stopping the at least one movement of the seat, and when the ratio is less than the first threshold, steps d) and e) are iterated with the next pressure value acquired by the third sensor and the next pressure value acquired by the first sensor.

In a particular embodiment, when the ratio remains below the first threshold, the seat movement is stopped when the seat reaches the destination configuration.

According to one particular embodiment, the method comprises placing the seat in a reference position in which a front edge of the squab is placed at a distance from a vehicle pedal, preferably an accelerator pedal; the distance being between 450 millimeters and 520 millimeters in a longitudinal direction.

According to one particular embodiment, the method further comprises the detection of at least one start of pedal depression, preferably of an accelerator pedal; and wherein the at least two attributes entered in the trained classification model are acquired within the second preceding the detection.

In a particular embodiment, the method comprises detecting a degree of pedal depression of at least 50% of the stroke of the pedal, the detection triggering the determination of a seat destination configuration.

In a particular embodiment, the sum is calculated from at least one pressure value acquired by the first sensor and at least one pressure value acquired by the second sensor.

In a particular embodiment, the first ratio is calculated from at least one pressure value acquired by the third sensor and at least one pressure value acquired by the first sensor.

According to one particular embodiment, the squab comprises at least one fourth sensor located on a front-left zone, and wherein the standard deviation is calculated from at least one pressure value acquired by the first sensor, at least one pressure value acquired by the second sensor, at least one pressure value acquired by the third sensor and at least one pressure value acquired by the fourth sensor.

According to one particular embodiment, the backrest comprises at least one fifth sensor located in an upper-right zone and/or at least one sixth sensor located in an upper-left zone, and which comprises the calculation of an additional attribute, the additional attribute comprising a second ratio between, on the one hand, at least one pressure value acquired by at least one of the fifth sensor and the sixth sensor and, on the other hand, at least one pressure value acquired by at least one of the third sensor and the fourth sensor.

According to one particular embodiment, the backrest comprises at least one fifth sensor located in an upper-right zone and at least one sixth sensor located in an upper-left zone, the calculation of an additional attribute, the additional attribute comprising a second ratio between, on the one hand, the sum of at least one pressure value acquired by the fifth sensor and at least one pressure value acquired by the sixth sensor and, on the other hand, the sum of at least one pressure value acquired by the third sensor and at least one pressure value acquired by the fourth sensor.

In a particular embodiment, the trained classification model is a decision tree.

According to one particular embodiment, the motion command signal emitted is configured to cause at least one movement from among:
moving the squab backwards or forwards relative to the reference position in the longitudinal direction of the vehicle;
lowering or raising the squab relative to the reference position in a vertical direction;
tilting the squab relative to the reference position at and along a transverse axis,
raising or lowering the headrest relative to the reference position.

The present disclosure also relates to a computer program comprising instructions for implementing the above-described method, when this program is executed by a processor.

The present disclosure relates to a method for controlling the configuration of a vehicle seat (11), the method comprising:
a) acquiring, (102) at a defined frequency, three pressure values by three sensors arranged on three defined zones of the squab;
b) calculating (110) attributes from the acquired pressure values, the attributes being selected from a standard deviation, a sum, and a first ratio;
c) determining (112) a seat destination configuration from the calculated attributes, by applying a trained classification model,
d) transmitting (114) a motion command signal to mobile motorized mechanisms, the motion command signal being suitable for causing the seat to move towards the determined destination configuration.

1. A method for controlling the configuration of a vehicle seat, the seat having a squab and a backrest, the method being implemented by a controller, the method comprising:
a) acquiring, at a defined frequency, at least three pressure values by at least three sensors arranged on at least three defined zones of the squab;
b) calculating at least two attributes from at least two of the three acquired pressure values, the calculated attributes being selected from a standard deviation, a sum, and a first ratio;
c) determining a seat destination configuration from the calculated attributes, by applying a trained classification model;
d) transmitting at least one motion command signal to mobile and motorized mechanisms, the at least one motion command signal being suitable for driving at least one movement of the seat towards the determined destination configuration.

2. The method of claim 1, wherein the calculation step comprises the calculation of three attributes.

3. The method of claim 1, wherein the squab comprises at least one first sensor arranged on a right rear zone, at least one second sensor arranged on a left rear zone, and at least one third sensor arranged on a right front zone, and wherein the standard deviation is calculated from at least one pressure value acquired by the first sensor, at least one pressure value acquired by the second sensor, and at least one pressure value acquired by the third sensor.

4. The method of claim 3, wherein, after the at least one motion command signal has been transmitted, the method comprises:
e) calculating a ratio between the pressure value acquired by the third sensor and the pressure value acquired by the first sensor;
f) comparing the ratio with a first threshold;
g) when the ratio is greater than the first threshold, at least one stop command signal is emitted to the mobile motorized mechanisms, the at least one stop command signal being suitable for stopping the at least one movement of the seat, and when the ratio is less than the first threshold, steps e) and f) are iterated with the next pressure value acquired by the third sensor and the next pressure value acquired by the first sensor.

5. The method of claim 1, which comprises placing the seat in a reference position wherein a front edge of the squab is placed at a distance from a vehicle pedal, preferably an accelerator pedal; the distance being between 450 millimeters and 520 millimeters in a longitudinal direction.

6. The method of claim 1, which comprises the detection of at least one start of pedal depression, preferably of an accelerator pedal; and wherein the at least two attributes entered in the trained classification model are acquired within the second preceding the detection.

7. The method of claim 1, which comprises detection of a degree of pedal depression of at least 50% of its stroke, the detection triggering the determination of a seat destination configuration.

8. The method of claim 3, wherein the sum is calculated from at least one pressure value acquired by the first sensor and at least one pressure value acquired by the second sensor.

9. The method of claim 3, wherein the first ratio is calculated from at least one pressure value acquired by the third sensor and at least one pressure value acquired by the first sensor.

10. The method of claim 3, wherein the squab comprises at least one fourth sensor located on a front-left zone, and wherein the standard deviation is calculated from at least one pressure value acquired by the first sensor, at least one pressure value acquired by the second sensor, at least one pressure value acquired by the third sensor and at least one pressure value acquired by the fourth sensor.

11. The method of claim 3, wherein the backrest comprises at least one fifth sensor located in an upper-right zone and/or at least one sixth sensor located in an upper-left zone, and which comprises the calculation of an additional attribute, the additional attribute comprising a second ratio between, on the one hand, at least one pressure value acquired by at least one of the fifth sensor and the sixth sensor, and, on the other hand, at least one pressure value acquired by at least one of the third sensor and the fourth sensor.

12. The method of claim 3, wherein the backrest comprises at least one fifth sensor located in an upper-right zone and at least one sixth sensor located in an upper-left zone, the calculation of an additional attribute, the additional attribute comprising a second ratio between, on the one hand, the sum of at least one pressure value acquired by the fifth sensor and at least one pressure value acquired by the sixth sensor and, on the other hand, the sum of at least one pressure value acquired by the third sensor and at least one pressure value acquired by the fourth sensor.

13. The method of claim 1, wherein the trained classification model is a decision tree.

14. The method of claim 6, wherein the motion command signal emitted is configured to cause at least one movement from among:
moving the squab backwards or forwards relative to the reference position in the longitudinal direction of the vehicle;
lowering or raising the squab relative to the reference position in a vertical direction;
tilting the squab relative to the reference position at and along a transverse axis,
raising or lowering the headrest relative to the reference position.

15. A method for automatically adjusting the configuration of a vehicle seat implemented by a controller and comprising:
i. determining a first set of seat occupant-specific indicators as a function of signals from a set of sensors, at least some of the sensors being integrated in the seat;
ii. determining a first set of target values as a function of the first set of indicators;
iii. transmitting command signals to mobile mechanisms of the seat so that the mechanisms are actuated and values measured via the sensors approach the determined target values;
iv. checking that preset conditions have been met to interrupt the method and the actuation of the mechanisms, at least some of the preset conditions involving reaching the target values determined by the measured values.

16. The method of claim 15, wherein the command signals are generated for mobile seat mechanisms capable of modifying at least one of the following parameters:
the forward position of the squab of the seat in relation to the rest of the vehicle;
the height of the squab of the seat relative to the rest of the vehicle;
the tilt of the squab of the seat, or of the front part of the squab of the seat, around a pitch axis;
the tilt between the squab of the seat and the backrest of the seat.
